(19) United States
(12) Patent Application Publication
(10) Pub. No.: US 2022/0230606 A1
(43) Pub. Date: Jul. 21, 2022

(54) Non-Amorphous Musical Instrument Components

(71) Applicant: Matthew Schiebold, Berkley, MI (US)

(72) Inventor: Matthew Schiebold, Berkley, MI (US)

(21) Appl. No.: 17/611,767

(22) PCT Filed: May 18, 2020
(86) PCT No.: PCT/US20/33439

§ 371 Date: Nov. 16, 2021

Related U.S. Application Data
(60) Provisional application No. 62/849,044, filed on May 16, 2019.

(51) Int. Cl. G10D 3/22; G10D 3/10; G10D 3/01; G10D 13/24

(52) U.S. Cl. CPC G10D 3/22; G10D 13/24; G10D 3/01; G10D 3/10

(57) ABSTRACT

A metallic component of a musical instrument is advantageously made of a vibration sustaining non-amorphous metal alloy including at least one metal selected from the group consisting of beryllium, copper, iron, titanium, chromium, scandium, lead, aluminum, silicon and combinations thereof, especially of a non-amorphous beryllium copper alloy. Duration of vibration is lengthened multiple fold with the use of this new material, on the order of 10 to 50 times longer. This yields a superior acoustic experience for a musician which enhances the quality of their performance.

### CROSS-REFERENCE TO RELATED APPLICATIONS

This application claims the benefit under 35 U.S.C. 119(e) of this U.S. Provisional Application filed herewith.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS WEB)

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

The present invention relates to musical instrument components, methods of manufacturing same, and methods of using same. More particularly, the invention relates to non-amorphous metallic alloy musical instrument components having superior acoustic qualities.

### 2. Description of the Prior Art

Conventional musical instrument components are well known in the art, including one of the most common types of metallic components, such as cello end pins, contra bassoon endpins, guitar necks and trusses, as well as strings for string instruments, along with other brass, percussion, piano and other keyboard instruments that include metallic components.

However, practitioners of those inventions have become aware of certain problems which are presented by those prior art inventions. One particular problem that has plagued users has been that there has been a relatively short duration of acoustic vibration exhibited by such musical instrument components. There are complexities which give rise to diminished articulation and clarity, transfer of sound with great distortion and shortened vibrational durations.

Musical instruments are formed from various components. As one non-limiting example, a cello can be formed from a back, sides, top, fingerboard, scroll, strings, bridge, tailpiece, tuning pegs, an endpin and others. The components can be formed from various materials and/or combinations of materials. The materials forming the components can contribute to the characteristics of the sound emanating from the musical instrument.

It would be advantageous to the musical industry if the components forming the musical instrument could be formed from materials configured to improve the sound emanating from the musical instrument.

Studies have indicated that light materials carry sound vibrations better than dense, heavy objects. The elasticity of a material, designated as its “springiness”, is also important for transmitting sound. It has been shown that less elastic substances such as hard foams and paper are actually more likely to absorb sound than carry it. It is the general consensus that the best materials for carrying sound waves probably include some metals such as aluminum, and hard substances like diamond.

The formula for the speed of sound in different properties is crucial to understanding why certain properties carry sound better. The velocity of a sound wave is equal to the square root of the elastic property divided by the density of the object. In other words, the less dense an object is, the faster sound travels, and the more elastic it is, the faster sound travels. An object will therefore conduct sound slower if it is not very elastic and is very dense.

Those studies have evaluated the speed at which sound travels through a material, and they found that one of the fastest rates was through aluminum, at 6,320 meters per second. This is because aluminum is not particularly dense, meaning that it has little mass in a given volume and aluminum is extremely elastic and capable of changing shape easily. The elasticity of a particular material tends to fluctuate more than its density and is therefore considered more important for understanding the speed of sound through the given material.

The next fastest speed for sound is 4,600 meters per second in copper. With its elasticity and ability to vibrate in place easily, sound travels through quickly. However, it is much more dense than aluminum, which explains why it is nearly two-thirds slower than aluminum.

At normal room temperature and pressure, the speed of sound is 343 meters per second, or about 20 times slower than in aluminum. One measurement that will affect speed is temperature, i.e. the hotter something is, the faster sound moves through it since it increases the speed of the molecules. For example, sound is 12 meters per second faster in 40 degrees Celsius than it is in 20 degrees Celsius.

While the speed of sound through a material is important in a musical instrument, it is more important for an instrument to exhibit a long duration of vibration, such that a player can experience a continuous vibration relating to a particular note for a longer period of time. This ability to have a significantly longer duration of vibration provides more forgiveness, resulting in improved articulation and clarity for both single and multiple notes.

Prior art disclosures of amorphous materials have stated that non-amorphous metallic components perform badly, and these prior art patents have specifically taught away from incorporating non-amorphous metal alloys into the metallic components of musical instruments. However, the present inventor went in the opposite direction when he discovered that non-amorphous metallic alloys exhibit higher quality sounds through their use, as well as making the instruments easier to play, without distortion, and with better articulation and clarity. For hundreds of years, the music industry has succumbed to the production of lesser quality sound with sound dulling amorphous metallic components.

It would be desirable to the music industry if there was provided a novel material exhibiting long duration vibrational characteristics for metallic musical instrument components, a method of making such a material into a musical instrument component, and a method of using the same.

### SUMMARY OF THE INVENTION

In accordance with the above-noted desires of the industry, the present invention provides various aspects, including a novel non-amorphous metallic musical instrument component, a method of making same, and a method of using it. This includes, for example, at least a non-amorphous beryllium copper metal alloy, and other lightweight metallic alloys for use as metallic components of musical instruments. Further, this new material overcomes the aforementioned problems with the prior art because sound is transferred without distortion, articulation and clarity, and vibrational duration is dramatically increased.

A first aspect of the present invention includes certain features for metallic components of musical instruments being made of non-amorphous metallic alloys including various low atomic weight elements such as beryllium alloyed with copper and iron. Further, nanometer layers of other low atomic weight elements, such as boron, carbon or nitrogen, may be laid down onto the non-amorphous beryllium copper alloy, where borophene, graphene, and other 2-dimensional constituents can be formed thereon as an acoustic carrying structure.

Another aspect of the invention has certain features including other low atomic weight elemental constituents alloyed with steel and other ferritic materials, such as IIA, IIIA, IVA and VA elements and low atomic weight transition metals.

The invention is particularly useful for applications of metal components of string instruments along with brass, percussion, piano and other keyboard instruments.

Although the invention will be described by way of examples hereinbelow for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings, in which often times like parts are given the same reference numerals, and wherein;

FIG. 1A is a front elevational view of a cello having an endpin comprised of a beryllium copper alloy made in accordance with the present invention;

FIG. 1B is a side elevational view of the cello having an endpin made of the beryllium copper alloy;

FIG. 2 illustrates such an endpin at the bottom of a cello;

FIG. 3 is an enlarged fragmentary view of a tail gut made of a non-amorphous alloy in accordance with the present invention;

FIG. 4A is a top perspective view of a tailpiece;

FIG. 4B is a bottom perspective view of the tailpiece of FIG. 4A;

FIG. 4C is an enlarged view of a string made in accordance with the present invention;

FIG. 5 is a perspective view of a flute made of non-amorphous materials in accordance with the present invention;

FIG. 6 illustrates a collection of string instruments which would benefit from the present invention;

FIG. 7 is a perspective view of a bow utilizing the present invention;

FIG. 8 illustrates a collection of wind instruments that include metallic components finding benefit with the use of the present invention;

FIG. 9 is a front elevational perspective view of a piano utilizing strings made of the metallic alloy of the present invention; and

FIG. 10 is a collection of percussion instruments including metallic components.

### DETAILED DESCRIPTION OF THE INVENTION

Looking first to the non-amorphous metallic alloys preferred for the present invention, an unexpectedly good acoustic result has been discovered for metallic components of musical instruments made of non-amorphous alloys, notably alloys of Beryllium copper (BeCu), which is also known as copper beryllium (CuBe), or beryllium bronze. Such a suitable CuBe alloy may include from 0.01% to 99.99% by weight of beryllium, balance of copper or their combinations with other suitable metals. Preferred beryllium copper alloys include from 0.5-3% by weight of beryllium, with the balance being copper, although other elements may be included in the copper alloy.

Since prior art patents have specifically taught away from the use of non-amorphous metallic alloys, the present invention came about in a particularly unpredictable manner. In particular, I discovered that non-amorphous beryllium copper alloys used as the metallic components of musical instruments provide a much longer vibration duration than the prior art amorphous materials, thereby exhibiting improved multi-note articulation and singular note clarity. Sound is transferred in the non-amorphous materials without distortion, and this effect renders an instrument easier to play because the musician can count on the clarity of the note for a longer period of time, providing predictability of notes generated.

Once I followed a divergent path for my material selection, solid musical components, such as a neck, fingerboard, tailpiece, and peg, bridge, and tail gut, were also manufactured by milling ingots of beryllium copper or other suitable alloys. This method is described more fully hereinbelow. The strings that would be made of beryllium copper would be made of non-amorphous metals and their alloys, especially of alloys made of high beryllium content beryllium copper.

For example, traditional steel strings on stringed instruments generally have a vibration duration of up to 30 seconds. By substituting those steel strings with beryllium copper strings, vibration duration is experiencing greater than a 2 min. and 40 seconds duration. Again, a longer vibration duration provides superior acoustic qualities.

My discovery of utilizing non-amorphous metal alloys for metallic musical components demonstrated that the beryllium copper alloy combines high strength with non-magnetic and non-sparking qualities. It exhibits excellent metalworking, forming and machining properties. In certain aspects in accordance with the present invention, I have found that my preferred beryllium copper alloy has many specialized applications in tools for musical instruments in whole or in part, strings, and other acoustic applications.

This means that many metal musical component parts can be replaced by my non-amorphous metals and many wooden parts can be replaced by the metal or a combination of wood and metal. For example, base bridges used in have adjustable components, normally used as a seasonal adjustment for temperature and humidity, that are made of plastic or aluminum. Previously unknown, the present invention proposes that Beryllium copper would be a perfect replacement for a base bridge. By using a beryllium copper alloy as the base bridge, this will improve the sound quality of the instrument. Beryllium copper will also provide enhanced sound and acoustic qualities to plucked instruments such as guitars, whether it is acoustic or electric, as well as harps. Electric guitars, and some acoustic guitars, have a truss rod which goes from the body to the neck, and these components can be replaced by the non-amorphous materials to improve the sound.

Furthermore, brass instruments, percussion instruments, pianos and other keyboard instruments such as the glockenspiel, would also benefit from the extraordinarily long vibration duration of the present invention.

In addition, and going a bit high tech, I discovered that by applying an outer layer of two-dimensional (2D) materials, such as graphene, BN, silicene, germanene, phosphorene, transition metal dichalcogenides, arsenene, and antimonene, metallic musical components exhibit dramatically increased vibrational properties. As detailed below, 2D materials have been synthesized by me or theoretically predicted by me as exterior layers deposited on the metallic component of any musical instrument.

Graphene and borophene show some unique physical and chemical properties. Graphene is a sound source device where it not only produces high sound pressure levels, it also has the advantage of bending and stretching. Mechanical vibration of a thin film drives air to produce sound. It is best to have a large energy area to build a sufficient sound field, and graphene can be quite thermoacoustic. For example, frequencies developed by graphene can be two times more than traditional sound production because graphene nanotubes act as an array of micro-organ pipes that trap the sound as is it moves across the surface without loss.

For instance, one phase of borophene possesses a buckled structure with the adjacent row boron atoms corrugating along the zigzag direction. Along the other in-plane direction, i.e. in the armchair direction, the atomic structure is un-corrugated. Interestingly, the Poisson's ratios along both in-plane directions are negative. Highly anisotropic mechanical properties have been observed. The Young's modulus along the armchair direction can be up to 398 N/m, which is even larger than that of graphene. However, the Young's modulus along the zigzag direction is only 170 N/m.

Certain boron allotropes have formation energies that are within a few meV/atom of the ground-state line. This polymorphism of 2D boron is completely different from other 2D materials: 2D carbon (graphene), Si (silicene), Ge (germanene), boron nitride (h-BN) and black phosphorus (phosphorene). Graphene, h-BN, silicene, and germanene display a distinct honeycomb structure. It has been shown such honeycomb structures provide better acoustic conduction, when applied to suitable substrates, such as metallic musical components described more fully hereinbelow. The frequency of the sound waves is from 100 Hz to 50 kHz.

Fully hydrogenated phases of borophene possess a Dirac cone along the X-Γdirection in the Brillouin zone with the Dirac point located at the Fermi level perfectly. Ultrahigh Fermi velocity of 3.5×106 m/sec, which is even larger than that of graphene, has been observed. The Young's modulus of the fully hydrogenated phase of borophene along the two in-plane directions is expected to be 172.24 and 110.59 N/m, respectively. The ultimate tensile strains along the zigzag and biaxial directions could be up to 0.30 and 0.25, respectively. Fermi velocities can be tuned in a large range by mechanical strains, indicating acoustic suitabilities. Especially extraordinary mechanical properties have been found in boron nanoribbon networks, which bodes well in the acoustic simulation models.

These two-dimensional structures also show high anisotropy. Along the armchair direction, the band structure shows metallic character; however, along the zigzag direction, a large band gap is observed. Ultrafast surface ion transport along the armchair direction has been found. Growth of 2D materials including graphene, borophene on silver and copper surfaces at various temperatures exhibited superior results when those samples were grown at Yale University in an ultra-high vacuum low-energy electron microscope (LEEM) equipped with an MBE system. During and after the growth process, the sample was bombarded with a beam of electrons at low energy and analyzed the low-energy electron diffraction (LEED) patterns produced as electrons were reflected from the crystal surface and projected onto a detector. Because the electrons have low energy, they can only reach the first few atomic layers of the material. The distance between the reflected electrons (“spots” in the diffraction patterns) is related to the distance between atoms on the surface, and from this information, scientists can reconstruct the crystal structure.

In this case, the patterns revealed that the single-crystal graphene and borophene domains were only tens of nanometers in size—too small for fabricating devices and studying fundamental physical properties—for all growth conditions. They also resolved the controversy about the graphene and borophene's structure: both structures exist, but they form at different temperatures. The scientists confirmed their LEEM and LEED results through atomic force microscopy (AFM). In AFM, a sharp tip is scanned over a surface, and the measured force between the tip and atoms on the surface is used to map the atomic arrangement.

To promote the formation of larger crystals, the scientists then switched the substrate from silver to copper, applying the same LEEM, LEED, and AFM techniques. Brookhaven scientists Percy Zahl and Ilya Drozdov also imaged the surface structure at high resolution using a custom-built scanning tunneling microscope (STM) with a carbon monoxide probe tip at Brookhaven's Center for Functional Nanomaterials (CFN)—a U.S. Department of Energy (DOE) Office of Science User Facility. Yale theorists Stephen Eltinge and Sohrab Ismail-Beigi performed calculations to determine the stability of the experimentally obtained structures. After identifying which structures were most stable, they simulated the electron diffraction spectra and STM images and compared them to the experimental data. This iterative process continued until theory and experiment were in agreement.

From theoretical insights, copper was expected to produce larger single crystals because it interacts more strongly with graphene and borophene than silver. Copper donates some electrons to stabilize graphene and borophene, but the materials did not interact too much as to form a compound. Not only were the single crystals larger, but the structures of the graphene and/or the borophene on copper were different from any of those grown on silver. Because there were several possible distributions of vacancies on the surface, various crystal structures could emerge. The crystalline structure of either graphene or borophene could be modified by changing the metallic musical instrument substrate and, in some cases, the temperature or deposition rate.

The next step was to transfer the graphene or borophene sheets from the metallic copper surfaces to device compatible substrates. Scientists could then accurately measure resistivity and other acoustic properties important to device functionality in metallic musical components.

The components of musical instruments formed from non-amorphous metals will now be described with occasional reference to the specific aspects. The components of musical instruments formed from non-amorphous metals may, however, be embodied in different forms and should not be construed as limited to the aspects set forth herein. Rather, these aspects are provided so that this disclosure will be thorough and complete, and will fully convey the scope of the components of musical instruments formed from non-amorphous metals to those skilled in the art.

Unless otherwise defined, all technical and scientific terms used herein have the same meaning as commonly understood by one of ordinary skill in the art to which the components of musical instruments formed from non-amorphous metals belongs. The terminology used in the description of the components of musical instruments formed from non-amorphous metals herein is for describing particular aspects only and is not intended to be limiting of the components of musical instruments formed from non-amorphous metals. As used in the description of the components of musical instruments formed from non-amorphous metals and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.”

Accordingly, unless otherwise indicated, the numerical properties set forth in the specification and claims are approximations that may vary depending on the desired properties sought to be obtained in aspects of the components of musical instruments formed from non-amorphous metals. Notwithstanding that the numerical ranges and parameters setting forth the broad scope of the components of musical instruments formed from non-amorphous metals are approximations, the numerical values set forth in the specific examples are reported as precisely as possible. Any numerical values, however, inherently contain certain errors necessarily resulting from error found in their respective measurements.

The description and figures disclose components for musical instruments formed from non-amorphous metals (hereafter “instrument components”). The term “non-amorphous”, as used herein, is defined to mean any metal, metal alloy and/or combinations of metals having an ordered atomic-scale structure.

Generally, the use of non-amorphous metals, such as the non-limiting examples of Beryllium and its alloys, can enhance the positive sound and tonal characteristics provided by the musical instrument by virtue of the unique sonic and tonal characteristics of the non-amorphous metal. As described above, it is most preferable for utilizing a beryllium copper alloy for a metallic musical component including an alloy of beryllium composed of from 0.01% to 99% by volume, with the balance of copper and/or a copper alloy.

The use of the non-amorphous metal is contemplated for components of musical instruments including the non-limiting examples of stringed instruments, brass, percussion, woodwind and the like. As non-limiting examples, the components contemplated for formation using non-amorphous metals includes backs, sides, tops, fingerboards, scrolls, strings, bridges, tailpiece, tuning pegs, end pins and any other components that can contribute to the positive characteristics of the sound emanating from the musical instrument.

The term “positive characteristics of the sound”, as used herein, is defined to include unique sonic characteristics, such as the longitudinal velocity of the sound, the sheer velocity of the sound, the surface velocity of the sound, the acoustic impedance of the sound and the like.

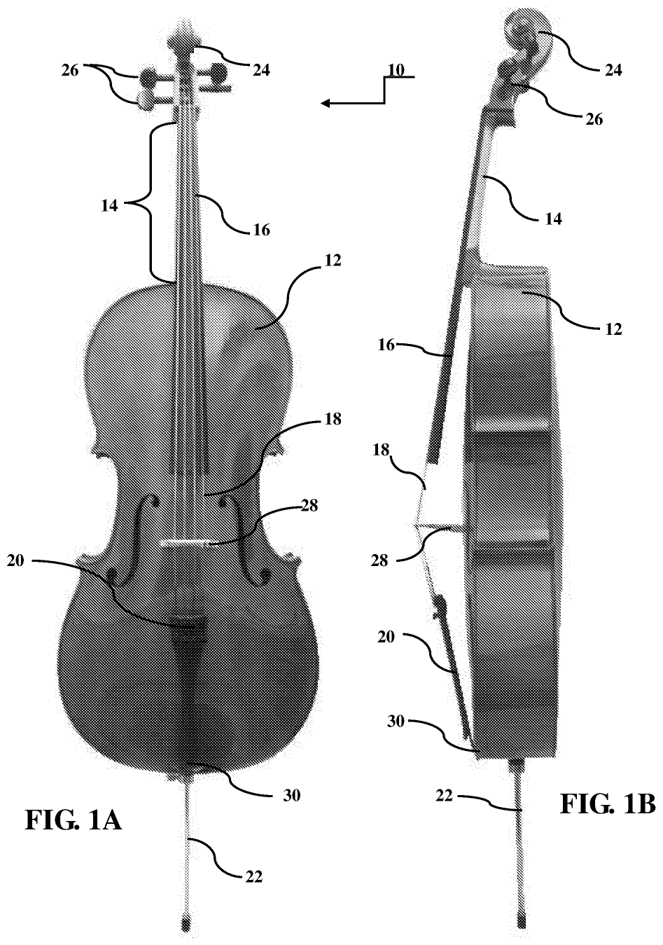

Referring now collectively to FIGS. 1A and 1B, a cello 10 is presented as one non-limiting aspect of a musical instrument having components formed from non-amorphous metal, non-amorphous metal alloys and/or combinations of non-amorphous metals. The components can include a cello body 12, fingerboard 14, neck 16, strings 18, endpin 22, tuning pegs 26, bridge 28, and tailgut 30, along with other conventional components. While this first aspect of the present invention is shown in FIG. 1 in accordance with the application of the present invention to a cello, it should be understood that many other musical instruments can have components formed from non-amorphous metal, non-amorphous metal alloys and/or combinations of non-amorphous metals.

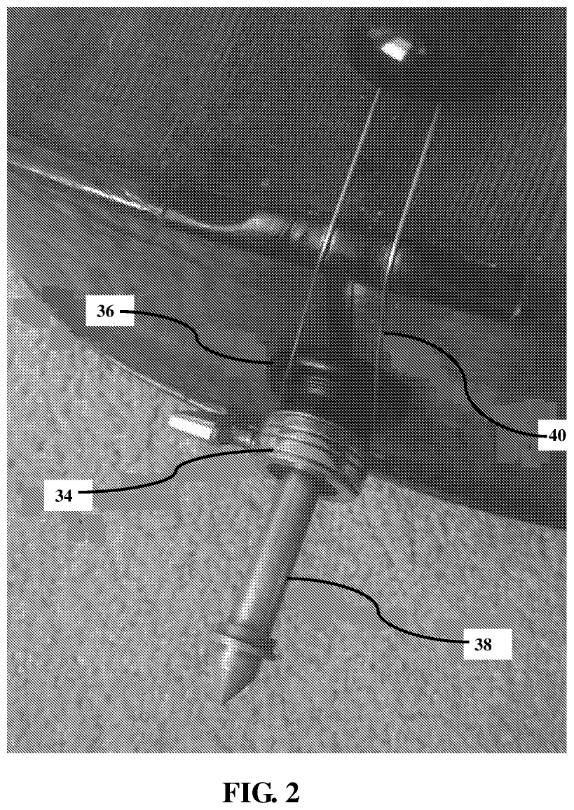

Referring now to FIG. 2, a portion of the cello 10 is presented. The cello 10 includes further examples of components formed from non-amorphous metal, non-amorphous metal alloys and/or combinations of non-amorphous metals, including beryllium copper alloys, such as the endpin collar 34, endpin housing 36, and pin 38 and tailgut 40.

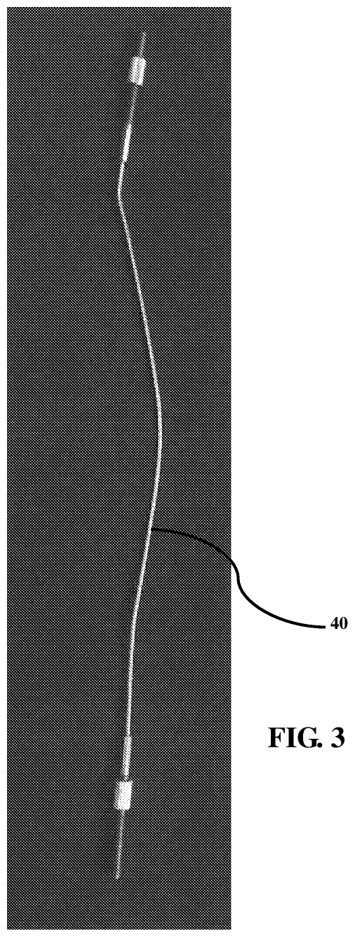

Referring next to FIG. 3, a representative tailgut 40 formed from non-amorphous metal, non-amorphous metal alloys and/or combinations of non-amorphous metals is presented.

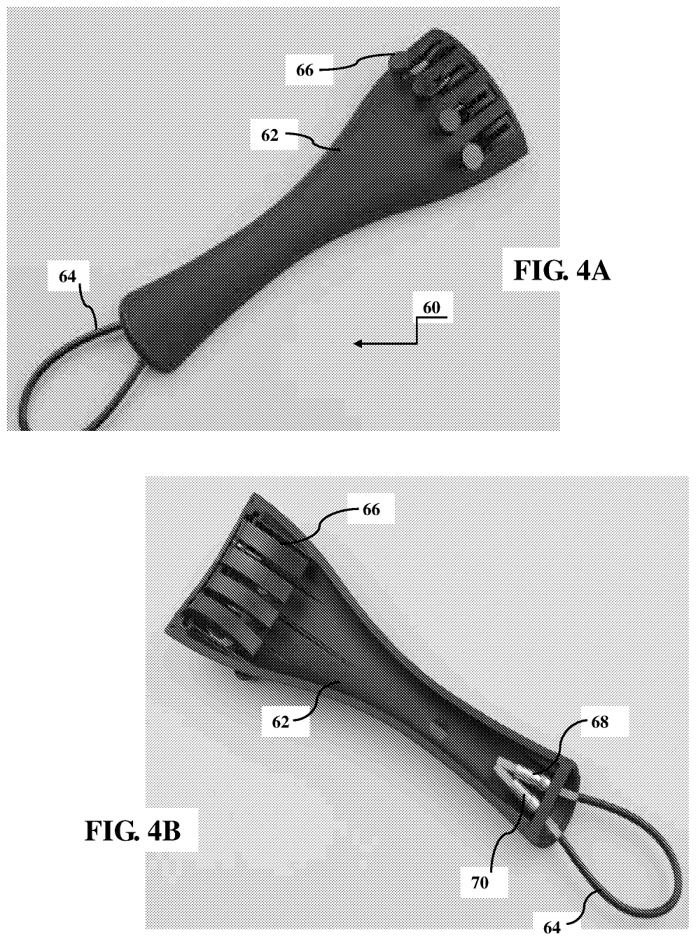

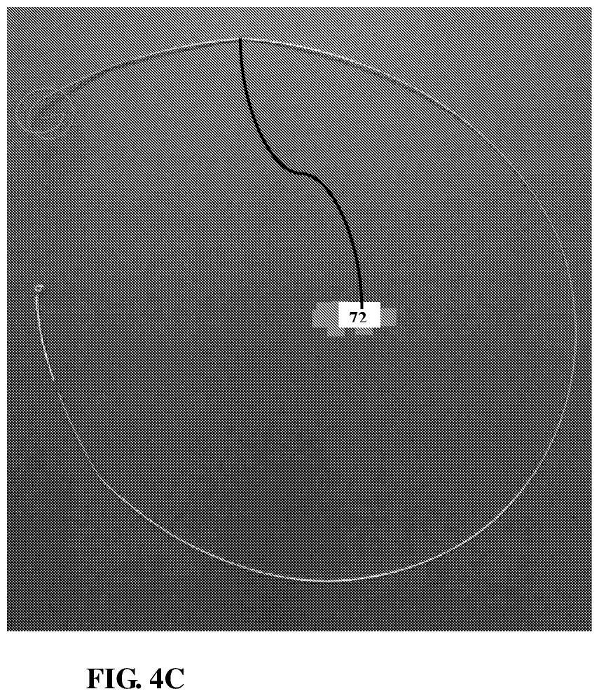

Referring collectively to FIGS. 4A and 4B, a tailpiece generally referred to by numeral 60 includes a tailpiece body 62, tailgut 64, fine tuners 66 and connectors 70.

Referring now to FIG. 4C, a representative string 12 formed from non-amorphous metal, non-amorphous metal alloys and/or combinations of non-amorphous metals is presented.

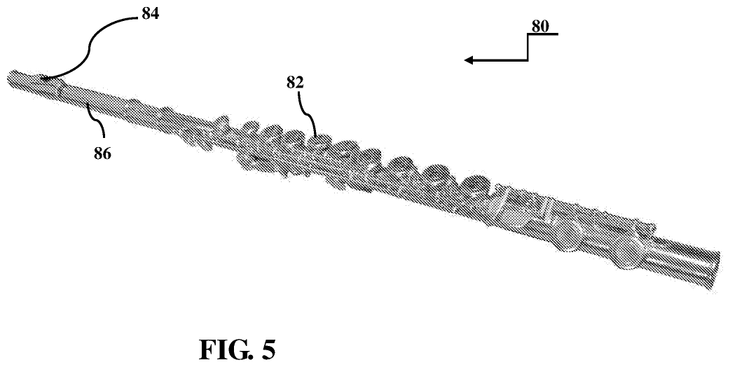

Referring next to FIG. 5, a representative wind instrument, such as the flute generally denoted by numeral 80, including keys 82, mouthpiece 84, and flute neck 86, all components preferably being formed from non-amorphous metal, non-amorphous metal alloys and/or combinations of non-amorphous metals is presented. Especially preferred if the entire construction being made of a beryllium copper alloy.

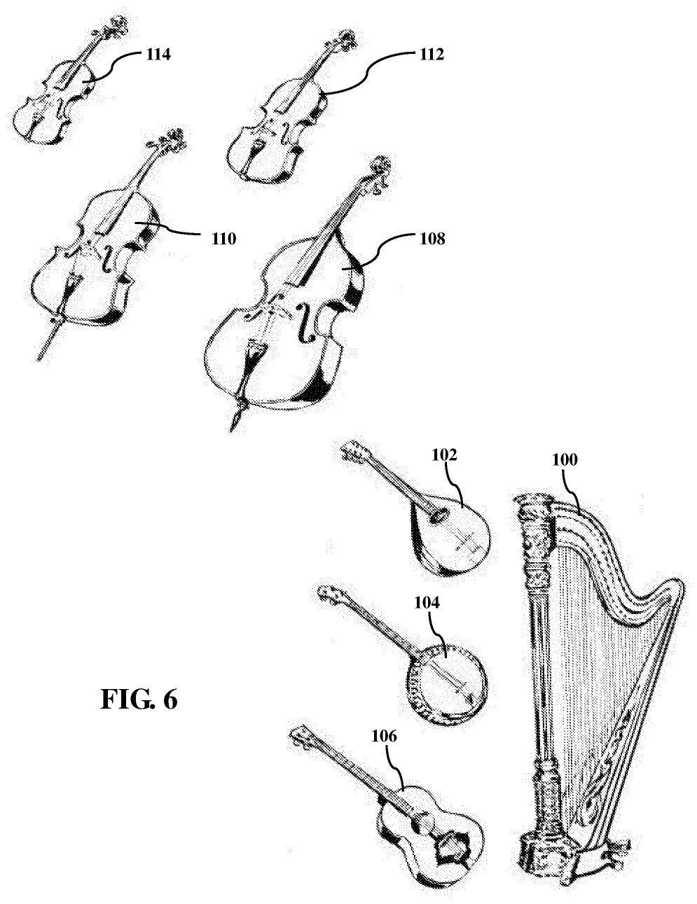

Referring now to FIG. 6, string instruments, such as harp 100, mandolin 102, banjo 104, guitar 106, cello 108, viola 110, violin 112, and violin 114 are representative string instruments that would benefit from incorporating strings of metallic components formed from non-amorphous metal, non-amorphous metal alloys and/or combinations of non-amorphous metals, such as beryllium copper alloys described hereinabove are presented.

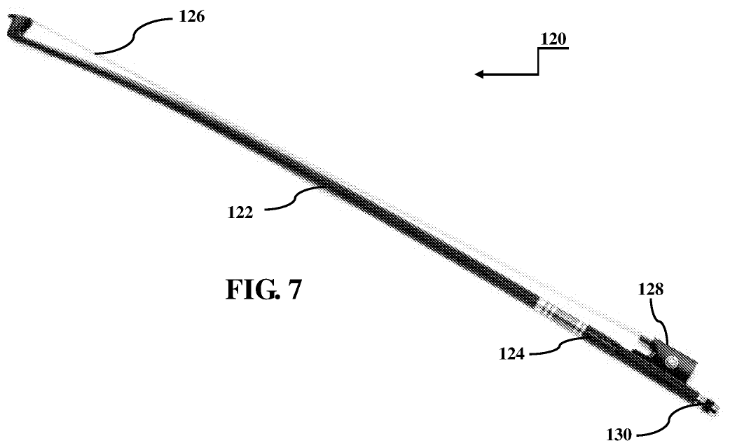

Referring now to FIG. 7, shown is a representative bow 120 including a stick 122, a grip 124, hair 126, frog 128, and screw 130, which may all be advantageously formed from non-amorphous metal, non-amorphous metal alloys and/or combinations of non-amorphous metals.

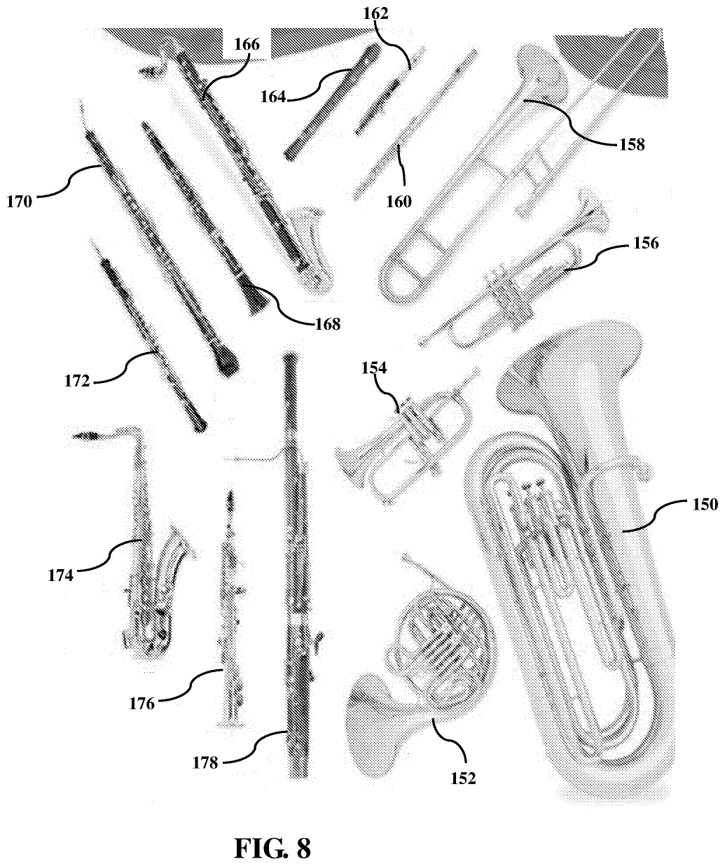

Referring now to FIG. 8, there is shown a representative collection of wind instruments, including tuba 150, French horn 152, flugelhorn 154, trumpet 156, trombone 158, flute 160, Piccolo 162, recorder 164, bass clarinet 166, clarinet 168, English horn 170, oboe 172, tenor saxophone 174, soprano saxophone 176, and bassoon 178 that would benefit from incorporating metallic components formed from non-amorphous metal, non-amorphous metal alloys and/or combinations of non-amorphous metals, such as beryllium copper alloys described hereinabove are presented.

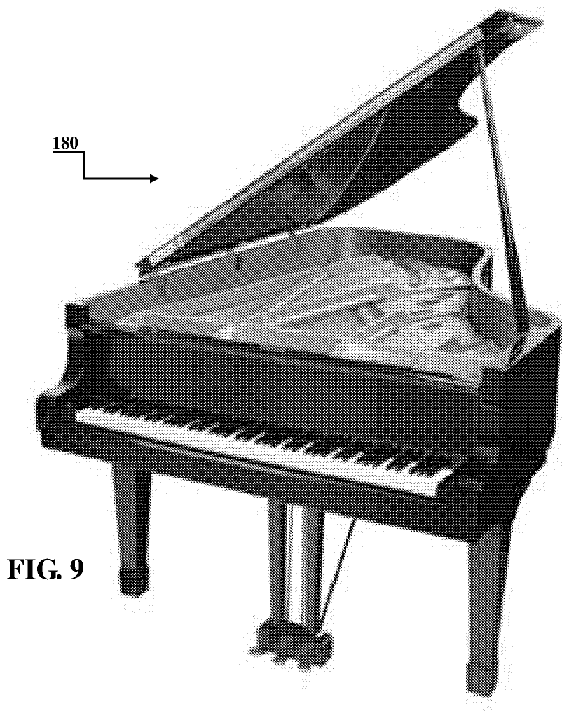

Referring now to FIG. 9, a representative piano denoted generally by the numeral 180 includes metallic components that would benefit from incorporating strings metallic components formed from non-amorphous metal, non-amorphous metal alloys and/or combinations of non-amorphous metals, such as beryllium copper alloys described hereinabove are presented.

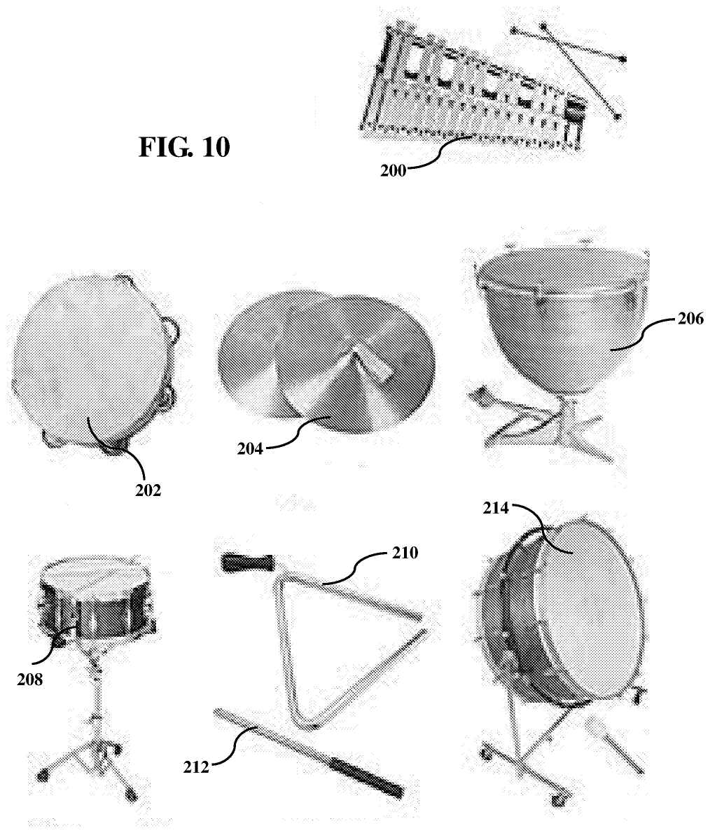

Referring lastly to FIG. 10, there is shown a representative collection of percussion instruments that all include metallic components that would benefit from incorporating metallic components formed from non-amorphous metal, non-amorphous metal alloys and/or combinations of non-amorphous metals, such as beryllium copper alloys described hereinabove are presented.

A metallic component of a musical instrument made in accordance with the present invention includes a vibration sustaining non-amorphous metal alloy including at least one metal selected from the group consisting of beryllium, copper, iron, titanium, chromium, scandium, lead, aluminum, silicon and combinations thereof. The metallic component of this musical instrument is preferably made of at least one metal selected from the group of elements from the periodic chart in columns IIA through VIA. The most preferred metallic component is made of a non-amorphous material comprising from 1% by weight beryllium, balance copper shaped into various musical components of musical instrument.

The present non-amorphous metallic component of musical instrument may also further comprise acoustic enhancing exterior coatings, such as an exterior two-dimensional layer of graphene, BN, silicene, germanene, phosphorene, transition metal dichalcogenides, arsenene, antimonene, and combinations thereof. The materials exhibit sound waves that mimic the electronic band structure of the two-dimensional layer of graphene, BN, silicene, germanene, borocene, phosphorene, transition metal dichalcogenides, arsenene, antimonene, or the combinations thereof. These materials may be deposited by chemical vapor deposition, plasma vapor deposition, spluttering or any similar method of epitaxially growing this acoustic enhancing exterior coating. Such coatings, especially graphene and borocene, adhered nicely to the beryllium copper alloys described herein, without flaking, chipping or sliding. When using graphene as an exterior coating on a beryllium copper alloy, the method of deposition is preferably chemical vapor deposition or plasma vapor deposition. A two-dimensional layer of graphene provides enhanced acoustic properties to the instrument while it is being played.

The non-amorphous metallic component has a frequency of the sound waves which is produced from 100 Hz to 50 kHz. Furthermore, the metallic component of a musical instrument is preferably made of a material having a specific gravity from 5.0 to 20.0.

The non-amorphous metallic component of a musical instrument especially is useful for a musical support structure such as an endpin for a cello or contrabassoon, but may also include substitution for any original metallic components for instruments used in all orchestral and tuned percussion instruments, such as horns, clarinets, triangles, Glockenspiels, chimes, tubular bells, gongs, bells, cymbals, and metallic string musical components such as piano strings, metallic piano components, guitar strings, metallic guitar components, and or tambourines.

### EXAMPLE

The following graph illustrates a comparison of the duration of vibration for various materials illustrating the unexpectedly good result of the non-amorphous metallic composition of the present invention. In this example, endpins made of carbon fiber, beryllium copper alloy, stainless steel, titanium and steel were suspended midway from a 10 pound monofilament line and was struck with a rawhide hammer with similar forces. As can be seen from the graph, the endpin made of the non-amorphous beryllium copper alloy exhibited a much longer duration of vibration, i.e. 2 min. and 20 seconds. The other materials all exhibited a much shorter duration of vibration. By selecting the non-amorphous beryllium copper alloy, a superior endpin was achieved. The beryllium copper material was made of an alloy having 2% by weight beryllium, 0.6% by weight lead, 0.2% by wt. aluminum, 0.2% by wt. silicon, balance of copper. The specific gravity of the alloy was 8.26. The endpins were drawn through a die, and then centerless ground by lathe turning to a final diameter of 10 mm. The length of the endpins for all the materials was approximately 20 inches. The test was performed by striking the endpin midway through its length as it was suspended. Duration of vibration was determined after sound became undetectable.

In accordance with the provisions of the patent statutes, the principle and mode of operation of the components of musical instruments formed from non-amorphous metals have been explained and illustrated in certain aspects. However, it must be understood that the components of musical instruments formed from non-amorphous metals, especially beryllium copper alloys, may be practiced otherwise than as specifically explained and illustrated without departing from its spirit or scope.

### INDUSTRIAL APPLICABILITY

The present invention finds industrial applicability and utility in the musical instrument industry, especially in the manufacture of metallic music components for musical instruments.

What is claimed is:

1. A metallic component of a musical instrument, comprising:
a vibration sustaining non-amorphous metal alloy including at least one metal selected from the group consisting of beryllium, copper, iron, titanium, chromium, scandium, lead, aluminum, silicon and combinations thereof.

2. The metallic component of a musical instrument of claim 1, wherein the at least one metal may also be selected from the group of elements from the periodic chart in columns IIA through VIA.

3. The metallic component of musical instrument of claim 1, further comprising an exterior two-dimensional layer of graphene, BN, silicene, germanene, phosphorene, transition metal dichalcogenides, arsenene, antimonene, and combinations thereof.

4. The metallic components of musical instrument of claim 3, wherein sound waves mimic the electronic band structure of the two-dimensional layer of graphene, BN, silicene, germanene, phosphorene, transition metal dichalcogenides, arsenene, antimonene, or the combinations thereof.

5. The metallic component of musical instrument of claim 4, wherein the frequency of the sound waves produced is from 100 Hz to 50 kHz.

6. The metallic component of a musical instrument of claim 1, wherein the non-amorphous material comprises from 1% by weight beryllium, balance copper.

7. The metallic component of a musical instrument of claim 1, wherein the metallic component of a musical instrument comprises a musical support structure.

8. The metallic component of a musical instrument of claim 1, wherein the metallic component of a musical instrument comprises an endpin for a cello.

9. The metallic component of a musical instrument of claim 1, wherein the metallic component of a musical instrument is made of a material having a specific gravity from 5.0 to 10.0.

10. The metallic component of a musical instrument of claim 1, wherein the metallic component of a musical instrument includes triangles, Glockenspiels, chimes, tubular bells, gongs, bells, cymbals, piano strings, metallic piano components, guitar strings, metallic guitar components, tambourines, tuned percussion instruments, and all other orchestral percussion instruments.
